(19) United States
(12) Patent Application Publication
(10) Pub. No.: US 2013/0097522 A1
(43) Pub. Date: Apr. 18, 2013

(54) METHOD AND SYSTEM OF GENERATING COMPOSITE WEB PAGE ELEMENTS WITH AN ANNOTATING PROXY SERVER

(71) Applicant: Derek A. Devries, San Francisco, CA (US)

(72) Inventor: Derek A. Devries, San Francisco, CA (US)

(21) Appl. No.: 13/274,330

(22) Filed: Oct. 15, 2011

(51) Int. Cl. G06F 3/048

(52) U.S. Cl. 715/745

(57) ABSTRACT

In one exemplary embodiment, a computer-implemented method can include the step of obtaining a first web page with a server. An element of the first web page that has been indicated by a first user is determined. A first profile element of the first user that is related to the element is obtained. A second profile element of a second user that is related to the element is also Obtained. A graphical representation of the first element and the second element is visually associated (e.g. with HTML code) with the element of the first web page in another element that overlays the element indicated by the first user.

### BACKGROUND OF THE INVENTION

1. Field

This application relates generally web browsing and proxy servers, and more particularly to a system and method of generating composite web page elements with annotating proxy server.

2. Related Art

Web applications have become increasingly popular as a result of their flexibility of deployment and their relatively intuitive interfaces. Moreover, online social networks have expanded the ability of end user of the Internet to interact with each other and share information. In a conventional online social networking experience a user logins and can view activities of friends on webpages that have been formatted and designed by the online social network administrator. If the online social network experience occurs on a web page that is not controlled by the online social network it can be relegated to a specified location in the web page such as a discussion section of the web page. Users are not able to share information with other users (such as social network connections) regarding other elements of the web page and have this information integrated into the other elements.

Thus, a method and system are desired for a system and method of generating composite web page elements with annotating proxy server to improve beyond existing methods of sharing information across the Internet.

### BRIEF SUMMARY OF THE INVENTION

In one embodiment, a computer-implemented method can include the step of obtaining a first web page with a server. An element of the first web page that has been indicated by a first user is determined. A first profile element of the first user that is related to the element is obtained. A second profile element of a second user that is related to the element is also obtained. A graphical representation of the first element and the second element is visually associated (e.g. with HTML code) with the element of the first web page in another element that overlays the element indicated by the first user.

In another exemplary embodiment, a computer-implemented method includes obtaining a first web page with an annotating proxy server. The first web page is requested using the annotating proxy server by a user's end device. The first web page is parsed into web page elements. The web page is configured such that a user can utilize an input device to indicate a web page element. A profile information about the user is obtained. The profile information includes at least one of a user's personal information, social networking information, web browsing history with the annotating proxy server information, an annotation of a past viewed web page generated by the annotating proxy server. A subportion of the profile information relevant to the web page element is determined. An annotation web page element including the web page element and the subportion of the profile information is generated. The annotated webpage element is integrated into a modified web page provided to the user's end device.

### BRIEF DESCRIPTION OF THE DRAWINGS

The present application can be best understood by reference to the following description taken in conjunction with the accompanying figures, in which like pa may be referred to by like numerals.

FIG. 1 illustrates an exemplary process for a system and method of generating composite web page elements with annotating proxy server.

FIG. 2 illustrates an example process of filtering user profile data for integration by an annotating proxy server into a composite web page document.

FIG. 3 illustrates another example process of filtering user profile data for integration by an annotating proxy server into a composite web page document.

FIG. 4 A-B illustrates another exemplary process for annotating a web page with an annotating proxy server.

FIG. 5 illustrates an example annotating proxy server system for implementation of certain embodiments of FIGS. 1-4.

FIG. 6 illustrates a sample computing environment which can be utilized in some embodiments.

FIG. 7 illustrates an exemplary computing system which can be configured to implement aspects of some embodiments.

FIG. 8 depicts an example of an embodiment used to generate a web page with a composite element that includes the original web page element and relevant user profile information.

### DETAILED DESCRIPTION OF THE INVENTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown, but are to be accorded the scope consistent with the claims.

### Process Overview

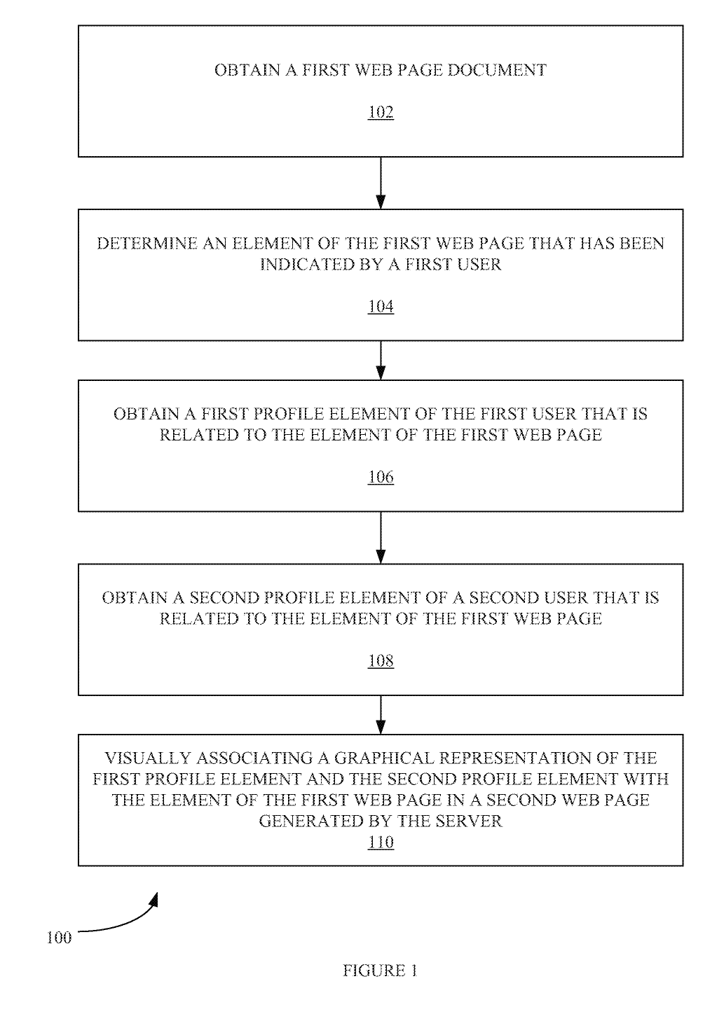

Disclosed are a system, method, and article of manufacture FIG. 1 illustrates an exemplary process for a system and method of generating composite web page elements with annotating proxy server. Although the present embodiments have been described with reference to specific example embodiments, it will be evident that various modifications and changes may be made to these embodiments without departing from the broader spirit and scope of the various claims.

FIG. 1 illustrates an exemplary process 100 for a system and method of generating composite web page elements with annotating proxy server. Regarding FIGS. 1-4, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with some embodiments, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with sonic embodiments.

In step 102 of process 100, a web page document is obtained and parsed with a server (e.g. a proxy server). For example, a personal computing device can include a web browser. The web browser can be connected with a computer network such as the Internet. The web browser can request a proxy server (e.g. a server (a computer system or an application) that acts as an intermediary for requests from clients seeking resources from other servers) obtain and parse the web page document. In step 104, an element of the first page that has been indicated by a first user is determined. For example, the first user can view the first web page on a personal computing device with a web browser and display. The user can use a user input device (key board, mouse pointer and the like) to indicate an element of the web page document that is displayed with the web browser. In step 106, a first profile element of the first user that is related to the element of the web page is obtained. For example, a profile of a user can be maintained. The profile can include such information as personal user information, user web browsing history as well as HTML code and other web page elements of web pages provided to the user within a specified period of time (as well as other webpage elements indicated by the user previously), user social networking data, user comments/webpage annotations, user-provided media (images, videos, audio and the like), user computer-enabled drawings (e.g. with a computerized drawing toot), any user interaction with a web page via the annotating server, etc. Recent profile information can be stored in a cache. Optionally, the proxy server can include a module for generating a graphical representation of profile data (e.g. as a user avatar, an element of a user avatar, in a human and/or animal form, etc). This graphical representation can be formatted for integration into a web page document that can include all or relevant portions of the first web page document. Similarly, in step 108, a second profile element of the second user that is related to the element of the web page is obtained. The second user can be anyone whose profile information has been acquired by the system described herein. For example, the second user can be connected to the first user in a social network. Similarly, the second user can have previously visited the first web page via the proxy server and indicated the element of the first web page. For example, the second user can have tagged (i.e., annotated) the element with a user comment, user-generated instruction o subsequent visitors, hyperlinks to other web pages and the like. The proxy server can also include a module that filters candidates for the second user from other members as well as fitters annotations by other users of the proxy server according to specified criteria (similar recent web browsing history, connected (explicitly and/or implicitly) in a social network, similar profile features, and the like). Optionally, the profile information of a plurality of other uses can be selected according specified parameters. Again, this information can be translated into a graphical representation for display with the web page and association with the web page element. In step 108, the graphical representation of the first element and the second element are visually associated with the element of the first web page. In various embodiments, the display the graphical representation of the user profile information can include such methods as integration of the graphical representation into a second web page document, provision of a widget that overlays the display of the first web page with a web browser and the like. Furthermore, the graphical representation can include elements of that are obtained from the first website (e.g. graphical representations of themes, subject matter, corporate proprietors of the first website, etc). A proxy server can perform process 100.

Optionally, users of the proxy server system can also annotate elements of web pages obtained through the proxy server system. These annotates can include user comments, user-provided media, hyperlinks, modifications of web page elements and the like. These annotations can be stored in the user's profile for later user as a user profile element.

Annotations can be implemented as a small application (e.g. web widget) that can be installed and executed within a web page by the annotating proxy server. The web widget can be integrated into the design of the indicated element of the first web page as well. Optionally, as users whose profile information is included in the web widget perform other operations (e.g. viewing other related web pages, annotating related web pages, leaving annotations on other web pages and the like) with the proxy server, the concomitant user profile information can be updated. In turn, the information in the web widget can also be updated by the annotating proxy server (e.g. in substantially real time assuming system latency).

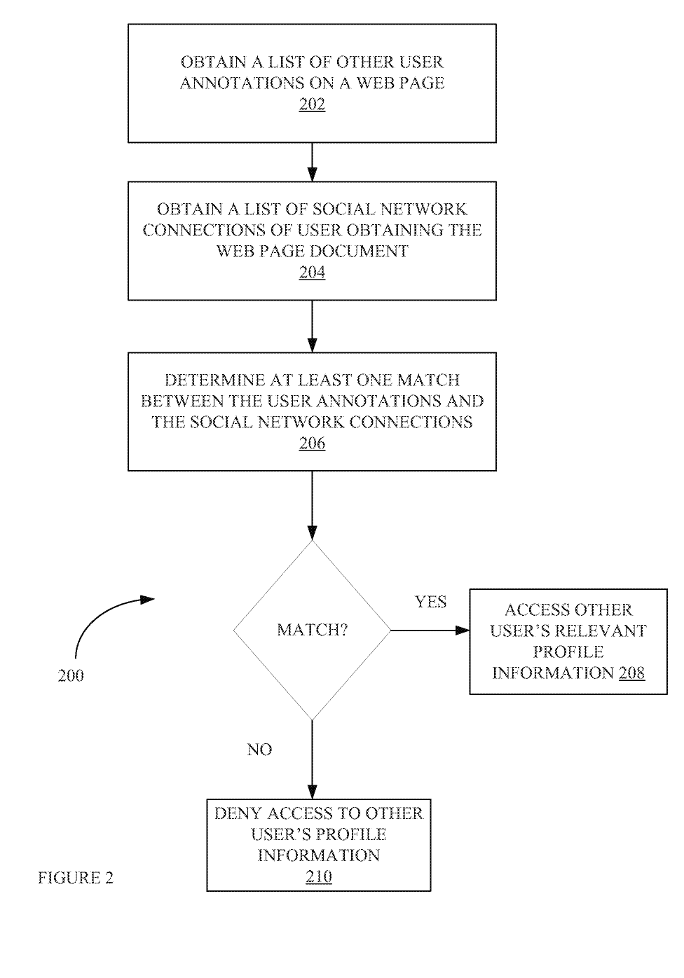

FIG. 2 illustrates an example process 200 of filtering user profile data for integration by an annotating proxy server into a composite web page document. In step 202 of process 202, a list of web page annotations of a web page is obtained by the annotating proxy server. For example, a user may utilize the annotating proxy server to access a particular web page. The annotating proxy server can obtain the web page document. The annotating proxy server can then determine if other users have provided the annotating proxy server annotations for elements of the web page. If the other annotations are located (e.g. in a database accessed by the annotating proxy server), he annotating proxy server can then obtain the annotations and the users who provided the annotations. In step 205, a list of the social networking connections (e.g. either explicit and/or implicit connections) is obtained by the proxy server. For example, the annotating proxy server can maintain and manage a computerized social network. Users can become ‘friends’ with each other and thus form connections in the social network. Other social networks can be implicit and formed based on certain user attributes. The annotating proxy server can include a social networking module that manages social networks. In step 206, the annotating proxy server can determine if a match exists between the list of users that provided user annotations and the social networking connections of the user utilizing the annotating proxy server to obtain the web page document. If a match if determined, in step 208 the annotating proxy server can access the profile information of the matched users. This profile information can be integrated by the annotating proxy server into another web page document that includes both the requested web page, the requesting user's profile information and/or the matching user's profile information. The annotating proxy server can formation this information for integration into the generated web page.

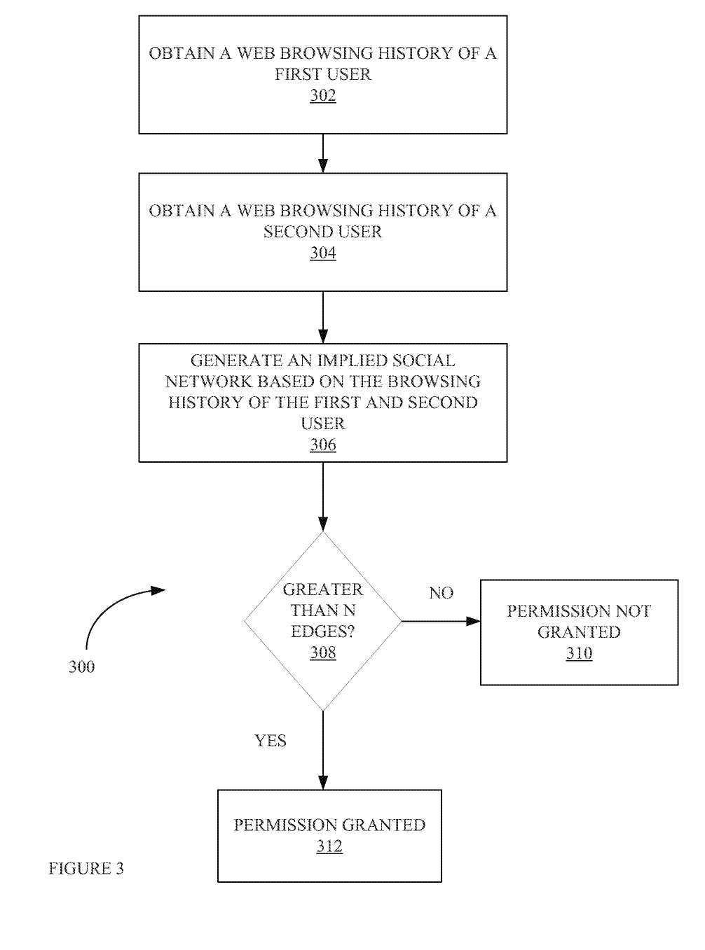

FIG. 3 illustrates another example process 300 of filtering user profile data for integration by an annotating proxy server into a composite web page document. In step 302 of process 300, the annotating proxy server can obtain a web history of a first user. For example, annotating proxy server can maintain a web browsing history of each user that navigates the Internet and/or other computer network utilizing the annotating proxy server. In another example, the annotating proxy server can query and receive the web browsing history from a web browser of a computing device of the first user. In step 302, the annotating proxy server can obtain a web browsing history of a second user. In step 304, the annotating proxy server can generate an implied social network based on the browsing history (as well as other data points such as user profile information, user login information and the like) of the first and second user. Thus, the annotating proxy server can maintain a database of users in order to generate an implied social network (e.g. with user profile information). In step 308, if there are greater than n edges (i.e. connections) between the first and second user, the annotating proxy server can then provide permission for another module of the annotating proxy server to integrate information about and/or provided by the second user to generate a second web page that substantially include aspects of the first web page, information about the first user and/or information about the second user in step 310. If there are less than n edges between the first and second user, the annotating proxy server can then deny permission to this information in step 310.

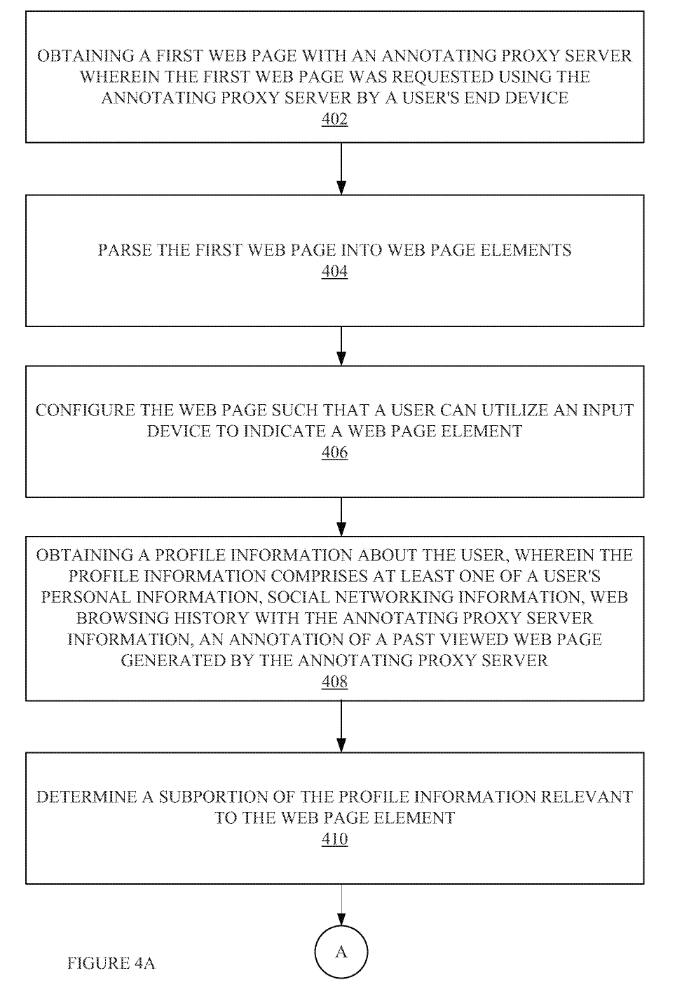

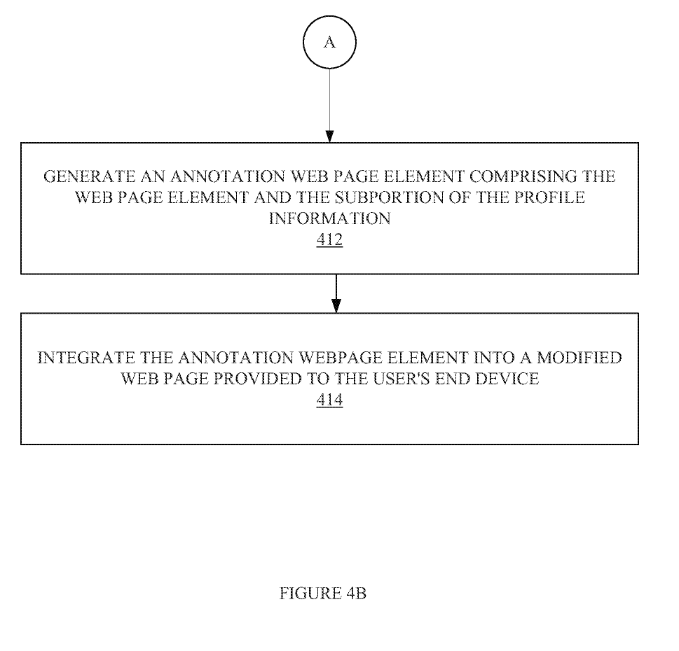

FIG. 4A-B illustrates another exemplary process 400 for annotating a web page with an annotating proxy server. In step 402 of process 400, a first web page is obtained with an annotating proxy server. The first web page can be requested by a user's end device (a web browser in a computing device such as a personal computer, a laptop, a tablet computer and/or a smartphone). Optionally, the request to the annotating proxy server can include user information (as obtained by a module in the end device). Moreover, user information can be collected by the annotating proxy server (e.g. registration information, user history using the annotating proxy server, user interactions with other members of a social network such as one maintained by the annotating proxy server, etc). In step 404, the web page can be parsed into elements (e.g. such as those delimitated by HTML, XML and/or similar other markup languages). The annotating proxy server can include a parser module. In step 406, the web page can be configured such that the user can utilize an input device to indicate a web page element (e.g. a portion of a web document the user wishes to annotate). In step 408, a user's profile information is obtained. The user's profile information can include information about the user and/or the user's behavior in the annotating proxy server system. For example, user's profile information can include such information as user's personal information, user's web browsing history (for a specified period of time), related social networking information, user's past modifications/annotations of web pages with the annotating proxy server, user comments about the indicated web element, user's networking ‘friends’ comments about the indicated web element, and the like. The user can be the user requesting the web page. In step 410, a subportion of the user's profile information that is relevant to the indicated web page element (e.g. as determined by a meaning of the web page element and/or a meaning of the subportion) is determined. Step 410 can be performed by tables that match categories of web page elements with categories of user's profile information, comparison algorithms, etc. In step 412 of process 400, an annotation web page element is generated. The annotation web page element can include the indicated web page element (e.g. a modified version of the HTML code (or other markup language) that is readable by a web browser that is compatible for integration with HTML code that generates the annotation that includes the relevant user profile information. In step 414, the annotation web page element and be integrated into a modified web page that is provided to the user's end device. Step 412 can be performed by the annotating proxy server.

The annotated web page can be stored by the annotating proxy server in a database and provided to other users of the annotating proxy server. Optionally, a timestamp that provide time of annotation can be associated with the annotated web page. The various user annotations can be removed from the annotated web page after a specified period of time.

In some embodiments, the annotated web page and/or annotations can also include commercials with hyperlinks offered by third party advertisers. Furthermore, annotations related to other users can optionally include fields for input by a viewing user. Input can include comments, hyperlinks, media and/or any combination thereof. The proxy server can notify a user that originally generated the annotation (e.g. via text message and/or email) if another user inputs comments into the annotation.

System Architecture

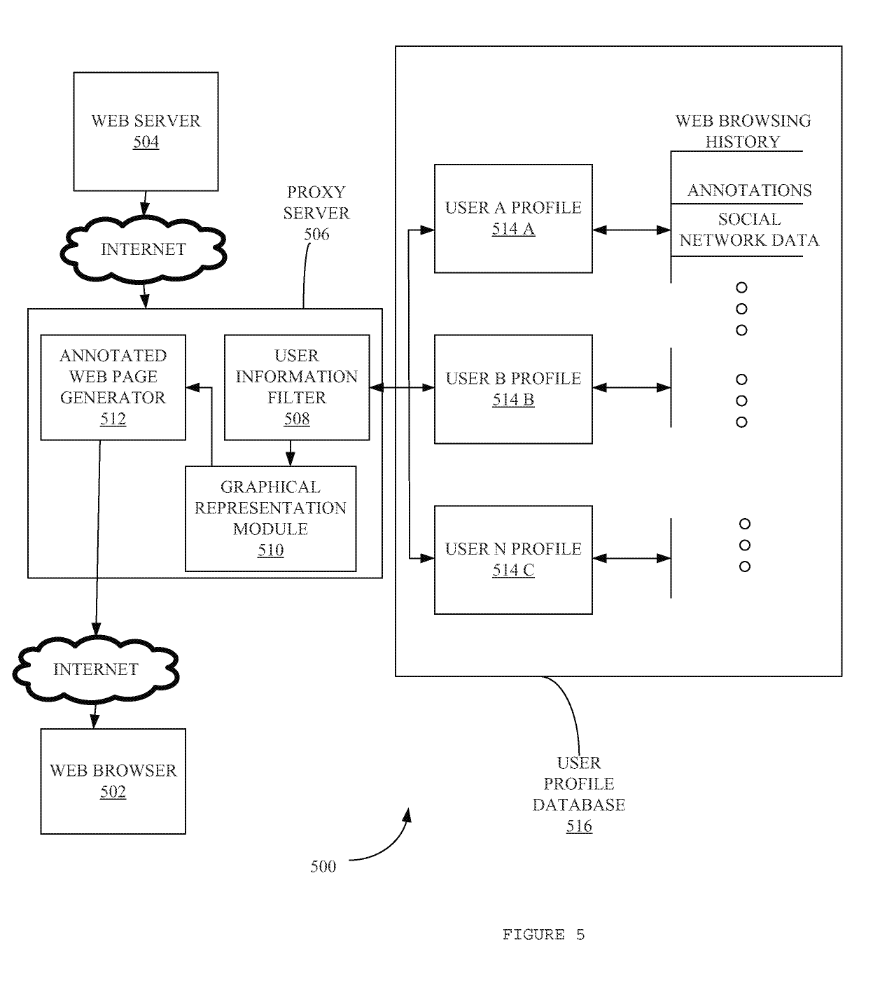

FIG. 5 illustrates an example annotating proxy server system 500 for implementation of certain embodiments of FIGS. 1-4. Annotating proxy server system 500 can receive a request from a web browser 502 to retrieve a web page from a third-patty web server 502. Annotating proxy server system 500 can include a proxy server 506. Proxy server 506 can typically include a computer system and/or an application that acts as an intermediary for requests from clients (user devices and applications therein such as web browser 502) seeking resources from other servers (e.g. web servers in the Internet). A client can connect to proxy server 506, request some service, such as a file, connection, web page, or other resource, available from a different server such as web server 504. Proxy server 506 can evaluate the request according to its filtering rules. For example, it may filter traffic by internet protocol (IP) address or protocol. If the request is validated by the filter, the proxy provides the resource by connecting to the relevant server and requesting the service on behalf of the client. A proxy server may optionally alter the client's request or the server's response, and sometimes it may serve the request without contacting the specified server. In this case, it ‘caches’ responses from the remote server, and returns subsequent requests for the same content directly. 100291 In addition to filtering the client's requests by IP address and other protocols, proxy server 506 can modify the results of the requests to include annotations of elements of the requesting user's profile. These elements can be relevant to aspects of the web page such as those indicated by the user. Optionally, proxy server 506 can modify the results of the requests to include annotations of relevant elements other users' profiles as well. These other users can be connected to the user via an explicit and/or implied social network. Proxy server 506 can also update profiles of various users based on indications by the indications and or modifications of the web page initiated by the user. Proxy server 506 can include a registration module (not shown) whereby users can create accounts and register with the annotating proxy server system 500. In some embodiments, proxy server 506 can perform a role similar to a network switch in linking two networks. In this way, proxy server 506 can serve as a gateway to a local proprietary network, of which the users are members, to the Internet.

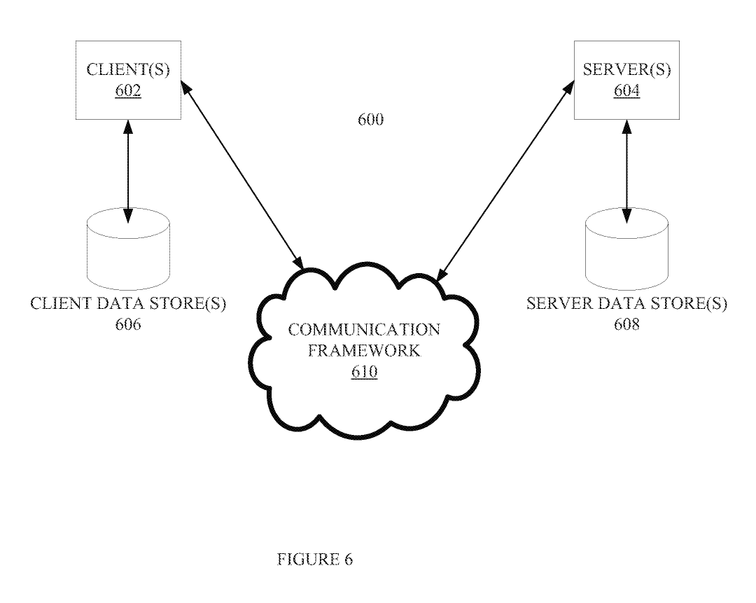

For example proxy server 506 can include a user information filter 508 that accesses a user profile database 516 to acquire user profile information from algorithmically selected of user profiles 514A-C (e.g. from the requesting user's profile, from requesting user's social network connections profiles, etc). As discussed supra, various criteria can be utilized to determine the selected user profiles such as proxy server general settings, requesting user settings (e.g. a user can modify settings of proxy server 506 to only provide annotations that include specified user profile information and the like). Information acquired by user information filter 508 can be provided to a graphical representation module 510. Graphical representation module 510 can generate a graphical representation of the user profile information. For example, graphical representation module 510 can utilize a common set of graphical elements for asocial network and/or obtain graphical elements of the web page. These elements can be modified to include the relevant user profile information obtained by user information filter 508. Optionally, user information filter 508 can also filter user profile information by other parameters such as recency of information input, location of user, user demographics, etc). Annotated web page generator 512 can integrate the graphical representation of the user profile information with web page elements into web page annotations. For example, annotated web page generator 512 can include a server-side scripting engine that takes the code and other data that makes up the web page and the user profile information and For example, annotated web page generator 512 can utilize server-side scripting language originally designed for web development to produce dynamic web pages. Annotated web page annotations can include attributes of both the web page element and the user profile information. Optionally, annotated web page annotations can also include attributes of recently visited web pages as well. It should be noted that data utilized by the proxy server 506 can be stored in a cache (e.g. in server data store 608 of FIG. 6 below) for later use.

FIG. 6 illustrates a sample computing environment 600 which can be utilized in some embodiments. The system 600 further illustrates a system that includes one or more client(s) 602. The client(s) 602 can be hardware and/or software (e.g., threads, processes, computing devices). The system 600 also includes one or more server(s) 604. The server(s) 604 can also be hardware and/or software (e.g., threads, processes, computing devices). One possible communication between a client 602 and a server 604 may be in the form of a data packet adapted to be transmitted between two or more computer processes. The system 600 includes a communication framework 610 that can be employed to facilitate communications between the client(s) 602 and the server(s) 604. The client(s) 602 are connected to one or more client data store(s) 1006 that can be employed to store information local to the client(s) 602. Similarly, the server(s) 604 are connected to one or more server data store(s) 608 that can be employed to store information local to the server(s) 604.

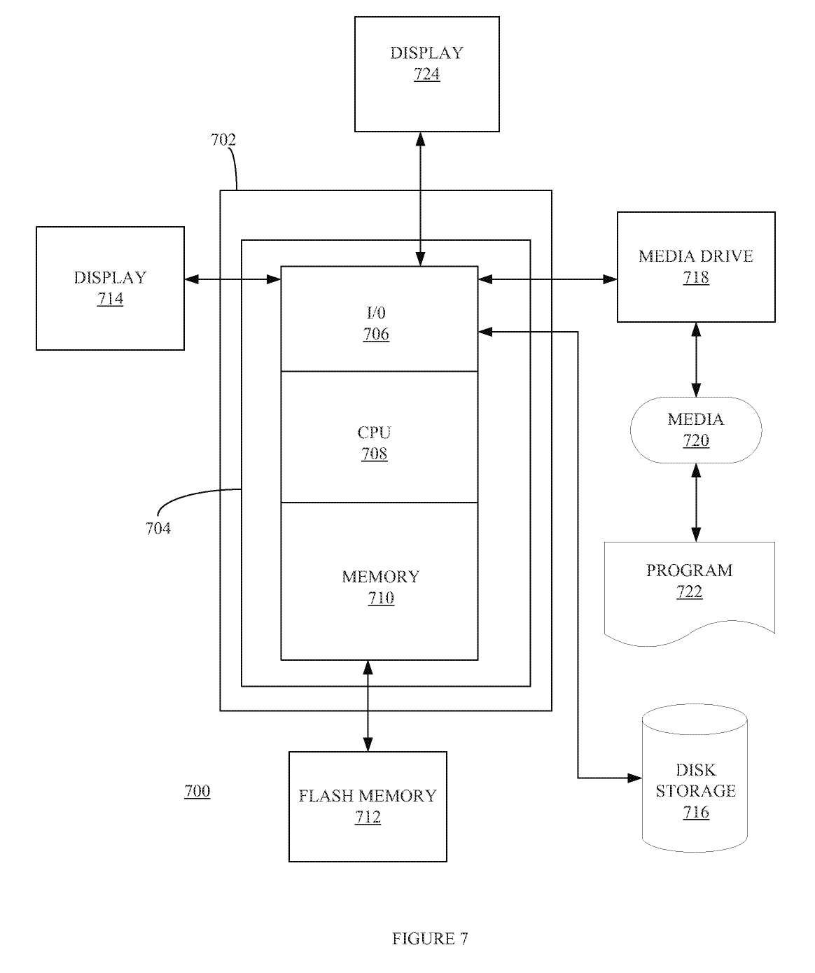

FIG. 7 depicts an exemplary computing system 700 that can be configured to perform any one of the above-described processes. In this context, computing system 700 may include, for example, a processor, memory, storage, and I/O devices (e.g., monitor, keyboard, disk drive, Internet connection, etc.). However, computing system 700 may include circuitry or other specialized hardware for carrying out some or all aspects of the processes. In some operational settings, computing system 700 may be configured as a system that includes one or more units, each of which is configured to carry out some aspects of the processes either in software, hardware, or some combination thereof.

FIG. 7 depicts computing system 700 with a number of components that may be used to perform the above-described processes. The main system 702 includes a motherboard 704 having an I/O section 706, one or more central processing units (CPU) 708, and a memory section 710, which may have a flash memory card 712 related to it. The I/O section 706 is connected to a display 724, a keyboard 714, a disk storage unit 716, and a media drive unit 718. The media drive unit 718 can read/write a computer-readable medium 720, which can contain programs 722 and/or data.

Example Use Cases

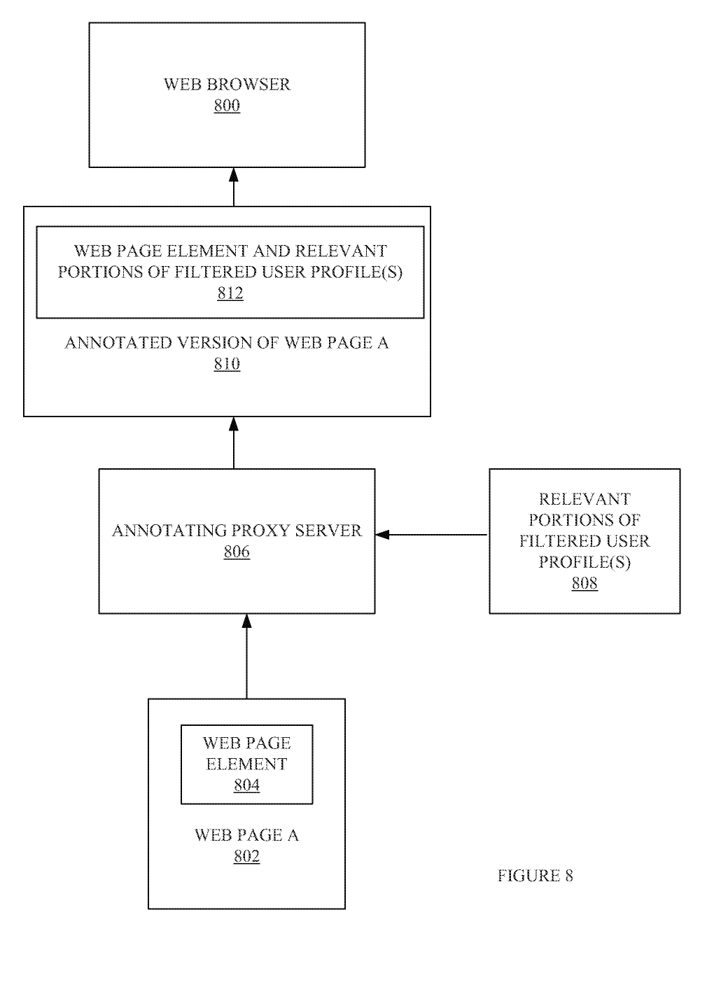

FIG. 8 depicts an example of an embodiment used to generate a web page with a composite element that includes the original web page element and relevant user profile information. A web browser 800 operated by an end user requests a web page 802. The web browser 800 can utilize a proxy server 804 to perform the request for web page 802. Web page 802 can reside in a remote server. Web page 802 can be a document or information resource that is suitable for the World Wide Web and can be accessed through a web browser 800 and displayed on a monitor or mobile device. This information is usually in HTML or XHTML format, and may provide navigation to other web pages via hypertext links. Web page 802 can subsume other resources such as style sheets, scripts and images into their final presentation. For example, web page 802 can include various visually discreet elements such as text, images, fields, video regions and the like. Annotating proxy server 806 can determine a class and/or type for each region. Annotating proxy server 806 can also identify the element (e.g. indicated web page element) and/or sub-portions of the element using such operations as image recognition and other image search algorithms (e.g. image meta search. Content-based image retrieval (CBIR), ALT tags, etc) for web page image elements, lookup of text definitions for web page text elements, and the like. Annotating proxy server 806 can then identify a list of end-user profiles and search a database of end user profile information for information 808 related to the class and/or type of the various discreet webpage elements. Annotating proxy server 806 can further reline the end user profile information 808 based on social network (explicit and/or implied) with the requesting end user. In one example, the annotating proxy server 806 can provide web page 802 to the end user who can then utilize the web browser to indicate discreet web page elements (such as web page element 804) of interest to the user. In this example, only the class and/or type of web page element 804 will be matched to filtered user profile information 808. Annotating proxy server 806 a visually integrate the filtered user profile information 808 with a web page element 804 in an annotated version of the web page 810 that now includes a composite web page element and relevant portions of filtered user profile(s) 812.

In another example (not shown), a user can create a web page trail for other invited users to follow. The web page trail can include a series of web pages I inked to each other through annotations put in place by the creating user. This information is stored in the proxy server. The other invited users can log-in with the proxy server which can provide them the first (as well as successive) web page. This example can be incorporated into an Internet game and/or educational experience. The progress of the invited users can be graphically rendered by the proxy server and overlaid as a web widget incorporated into the series of web pages in the trail. The proxy server can provide a dashboard type GUI to the inviting user that displays the various metrics (user progress, etc) associated with the poi participating users and the web page trail as well as enables the inviting user to modify the annotations associated with the web pages.

In another example (not shown), a user's particular profile (or a portion thereof) can be utilized to generate queries to the user. In this way, a user's identity can be verified. For example, a user may have indicated a particular element of a particular web page and input an annotation in the past. This information can be stored by the proxy server. The proxy server can include a functionality for providing a user verification protocol (e.g. CAPTCHA, a log-in widget, etc) that includes a query to this or other user-profile information.

In yet another example (not shown), user profile information can be provided to third-party advertisers. The advertisers can utilize the user information to generate their own annotations that can be integrated into element indicated by the user and/or web pages requested by the user. The advertisement annotations can also be integrated into associated user annotations.

Optionally, an annotating proxy server can include a web page stability module configured to compare a cached annotated version of a web page with a version from a third party web server to determine if there have been alterations to the original web page. If alterations are detected, the web page stability module can then reset (e.g. indicate that the annotation refers to a previous version of the web page) and/or remove relevant annotations associated with the web page and/or portions of the web page. A user can locally annotate any element or sub-element of a web page with the annotating proxy server.

### Conclusion

At least some values based on the results of the above-described processes can be saved for subsequent use. Additionally, a computer-readable medium can be used to store (e.g., tangibly embody) one or more computer programs for performing any one of the above-described processes by means of a computer. The computer program may be written, for example, in a general-purpose programming language Pascal, C, C++, Java) or some specialized application-specific language.

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it will be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be anon-transitory form of machine-readable medium.

What is claimed as new and desired to be protected by Letters Patent of the United States is:

1. A computer-implemented method comprising:
obtaining a first web page with a server;
determining an element of the first web page that has been indicated by a first user;
obtaining first profile element of the first user that is related to the element;
obtaining a second profile element of a second user that is related to the element; and
visually associating a graphical representation of the first element and the second element with the element of the first web page in another element that overlays the element indicated by the first user.

2. The computer-implemented method of claim 1, wherein visually associating a graphical representation of the first element and the second element with the element of the first web page further comprises:
generating a second web page comprising a modified version of the first web page, the first profile element and the second profile element.

3. The computer-implemented method of claim 2 further comprising:
providing the second web page to a computing device of the first user.

4. The computer-implemented method of claim 1, wherein the first element and the second element are related to a meaning of the element of the web page.

5. The computer-implemented method of claim 1, wherein the first profile element comprises a first web page annotation provided by the first user to be associated with the element of the first web page.

6. The computer-implemented method of claim 5, wherein the second profile element comprises a second web page annotation provided by the second user to be associated with the element of the first web page.

7. The computer-implemented method of claim 6, wherein a web page annotation comprises at least one of a user-provided comment, a user-provided image or, a metadata of a web-browsing history of the first user or the second user, a user-provided hyperlink to another web page document.

8. The computer-implemented method of claim 7 further comprising:
generating an HTML instruction, with the server, to display the first web page annotation and the second web page annotation in proximity with the element of the first web page in a second web page that comprises a substantial portion of the first web page, the first web page annotation and the second web page annotation.

9. The computer-implemented method of claim 7, wherein the first web page annotation is algorithmically selected based on a theme of the first web page.

10. The computer-implemented method of claim 7, wherein the second user profile is selected based on a ti k between the first user and the second user in a social network.

11. A computer-implemented method comprising:
obtaining a first web page with an annotating proxy server wherein the first web page is requested using the annotating proxy server by a user's end device;
parsing the first web page into web page elements;
configuring the web page such that a user can utilize an input device to indicate a web page element;
obtaining a profile information about the user, wherein the profile information comprises at least one of a user's personal information, social networking information, web browsing history with the annotating proxy server information, an annotation of a past viewed web page generated by the annotating proxy server;
determining a subportion of the profile information relevant to the web page element;
generating an annotation web page element comprising the web page element and the subportion of the profile information; and
integrating the annotated webpage element into a modified web page provided to the user's end device.

12. The computer-implemented method of claim 11, wherein the annotation webpage element is visually connected with the indicated webpage element.

13. The computer-implemented method of claim 12, wherein the annotation webpage element comprises another annotated webpage element generated by a another user.

14. The computer-implemented method of claim 13, wherein the annotation webpage element comprises an element of another recently-viewed webpage.

15. A computer readable medium comprising non-transitory computer executable instructions adapted to perform the method of claim 14.

16. A proxy server system comprising:
a web page acquisition module of the proxy server configured to obtain a first web page;
a user information filter of the proxy server configured determine an element of the first web page that has been indicated by a first user, to obtain a first profile element of the first user that is related to the element, and to obtain a second profile element of a second user that is related to the element;
a graphical representation module of the proxy server configured to create a graphical representation of the first element and the second element; and
an annotated webpage generator of the proxy server configured to visually associate a graphical representation of the first element and the second element with the element of the first web page in another element that overlays the element indicated by the first user.

17. The proxy server system of claim 16, wherein the annotated webpage generator is configured to generate a second web page comprising a modified version of the first web page, the first profile element and the second profile element.

18. The proxy server system of claim 17, wherein the annotated webpage generator is configured to provide the second web page to a computing device of the first user.

19. The proxy server system of claim 18, wherein the first web page annotation is algorithmically selected based on a theme of the first web page.

20. The proxy server system of claim 19, wherein the proxy server is configured to determine an identity of at least one sub-element of the element with an image recognition algorithm.
